(19) United States
(12) Patent Application Publication
(10) Pub. No.: US 2024/0328502 A1
(43) Pub. Date: Oct. 3, 2024

(54) DRIVE DEVICE

(71) Applicant: NIDEC CORPORATION, Kyoto (JP)

(72) Inventors: Taishi SATODA, Kyoto (JP); Ryosuke MATSUZAKI, Kyoto (JP); Yuki ISHIKAWA, Kyoto (JP); Yuta KURODA, Kyoto (JP)

(21) Appl. No.: 18/621,100

(22) Filed: Mar. 29, 2024

(30) Foreign Application Priority Data
Mar. 31, 2023 (JP) 2023-058158

(51) Int. Cl. F16H 57/04; F16H 57/02; F16H 57/021; H02K 5/16; H02K 5/20; H02K 7/08; H02K 7/116; H02K 9/19

(52) U.S. Cl. CPC F16H 57/0424; F16H 57/021; F16H 57/0471; H02K 5/161; H02K 5/203; H02K 7/083; H02K 7/116; H02K 9/19; F16H 2057/02034; F16H 2057/02043; F16H 57/0476

(57) ABSTRACT

A drive device includes a transmission in a housing, and a flow path. The transmission includes a shaft and a bearing supporting the shaft. The housing has a bearing holding portion that includes a facing surface on a first side in an axial direction with respect to an end on the first side of the shaft and orthogonal to the axial direction, and an inner surface extending from the facing surface to the other, second side in the axial direction and supporting the bearing. The flow path includes an inflow portion and an outflow portion below the inflow portion, both open to the inner surface. The facing surface has a rib protruding to the second side and orthogonal to the axial direction. At least a part of the rib is below the inflow portion, and at least a part of the rib covers the outflow portion from above.

### CROSS-REFERENCE TO RELATED APPLICATIONS

The present invention claims priority under 35 U.S.C. § 119 to Japanese Patent Application No. 2023-058158 filed on Mar. 31, 2023, the entire content of which is incorporated herein by reference.

### FIELD OF THE INVENTION

The present invention relates to a drive device.

### BACKGROUND

A drive device is mounted on a vehicle such as an electric vehicle and a hybrid vehicle. A fluid such as oil is stored in such a drive device, and the fluid lubricates gears and bearings in the drive device.

The bearing is held by a bearing holding portion provided in the housing. When a plurality of bearings are provided, it is required to stably supply fluid to each bearing and to suppress shortage of supply to some of the bearings.

### SUMMARY

An exemplary drive device according to an embodiment of the present invention includes a motor, a transmission mechanism configured to transmit power of the motor, a housing provided with a gear chamber that accommodates the transmission mechanism, and a flow path at least a part of which is provided in the housing. The transmission mechanism includes a first shaft rotatable about a first axis, and a first bearing that supports the first shaft. The housing includes a side wall covering the gear chamber from one side in an axial direction, and a first bearing holding portion that is provided on the side wall and holds the first bearing. The first bearing holding portion includes a first facing surface located on one side in an axial direction with respect to an end portion on one side in an axial direction of the first shaft and extending in a direction orthogonal to an axial direction, and a first inner side surface extending in an axial direction and supporting the first bearing from a radially outer side about the first axis. The flow path includes a first inflow portion that is open to the first inner side surface, and a first outflow portion that is positioned below the first inflow portion and open to the first inner side surface. The first facing surface is provided with a first rib protruding to an other side in an axial direction and extending in a direction orthogonal to an axial direction. At least a part of the first rib is located below the first inflow portion, and at least a part of the first rib covers the first outflow portion from above.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual diagram of a drive device of a first embodiment;

FIG. 2 is a front view of a side wall according to the drive device of the first embodiment;

FIG. 3 is a schematic cross-sectional view of a first bearing holding portion of the first embodiment;

FIG. 4 is a schematic view of a first bearing holding portion according to a first modification;

FIG. 5 is a schematic view of a first bearing holding portion according to a second modification;

FIG. 6 is a schematic view of a first bearing holding portion according to a third modification;

FIG. 7 is a cross-sectional view illustrating a first bearing holding portion of a fourth modification;

FIG. 8 is a front view of a side wall according to a drive device of a second embodiment;

FIG. 9 is a schematic view of a first bearing holding portion and a second bearing holding portion of a fifth modification;

FIG. 10 is a front view of a side wall according to a drive device of a third embodiment; and

FIG. 11 is a front view of a side wall according to a drive device of a fourth embodiment.

### DETAILED DESCRIPTION

A drive device according to an embodiment of the present invention will be described below with reference to the drawings. In description below, a vertical direction is defined based on a positional relationship when a drive device 1 of the present embodiment is mounted on a vehicle (not illustrated) positioned on a horizontal road surface.

In the drawings, an XYZ coordinate system is illustrated appropriately as a three-dimensional orthogonal coordinate system. In the XYZ coordinate system, a Z-axis direction corresponds to the up-down direction. The up-down direction is, for example, a vertical direction. A +Z side corresponds to an upper side in the vertical direction, while a −Z side corresponds to a lower side in the vertical direction. In the present embodiment, the upper side in the vertical direction will be referred to simply as the “upper side” and the lower side in the vertical direction will be simply referred to as the “lower side”. An X-axis direction is a direction orthogonal to the Z-axis direction and is a vehicle front-rear direction on which the drive device 1 is mounted. In the present embodiment, a +X side is a front side of the vehicle, and a −X side is a rear side of the vehicle. A Y-axis direction corresponds to a left-right direction of the vehicle, i.e., a width direction of the vehicle, and is a direction perpendicular to both the X-axis direction and the Z-axis direction. The Y-axis direction corresponds to the axial directions of a first axis J1, a second axis J2, and a third axis J3, which will be described later. Each of the front-rear direction and the left-right direction is a horizontal direction perpendicular to the vertical direction.

The first axis J1, the second axis J2, and the third axis J3, which are appropriately shown in each figure, are parallel to each other and extend in the Y-axis direction (that is, the left-right direction of the vehicle and the direction along the horizontal plane). In the present specification, unless otherwise specified, a direction parallel to the axes J1, J2, and J3 is simply referred to as an “axial direction”, a radial direction with the axis J1 as a center is simply referred to as a “radial direction”, and a circumferential direction with the axis J1 as a center, that is, around the axis J1 is simply referred to as a “circumferential direction”. In the following description, one side in the axial direction means a +Y side in the direction along the Y axis, and the other side in the axial direction means a −Y side in the direction along the Y axis. Note that, in the present embodiment, the “parallel direction” also includes a substantially parallel direction, and the “perpendicular direction” also includes a substantially perpendicular direction. In addition, in the present specification, “facing the axial direction” means facing a direction parallel to the axial direction or a direction having an axial component.

In the following description, a vehicle front-rear direction which is a direction parallel to the X axis is simply referred to as a “first direction”. The front side (+X side) of the vehicle is simply referred to as one side in the first direction, and the rear side (−X side) of the vehicle is simply referred to as the other side in the first direction. The first direction is a direction intersecting both the vertical direction and the axial direction.

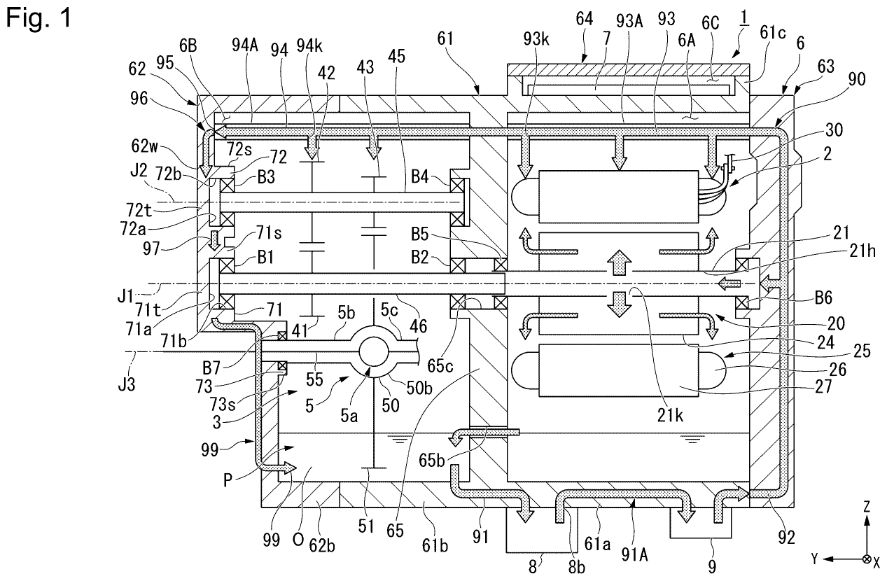

FIG. 1 is a conceptual diagram of a drive device 1 of a first embodiment.

The drive device 1 of the present embodiment is mounted on an electric vehicle (EV) and is used as a power source thereof. Note that, the drive device 1 may be mounted on a vehicle including a motor as a power source, such as a hybrid electric car (HEV) or a plug-in hybrid electric car (PHV).

As illustrated in FIG. 1, the drive device 1 includes a motor 2, a transmission mechanism 3, an inverter 7, a housing 6, a fluid O, a pump 8, and a cooler 9. The motor 2, the transmission mechanism 3, and the inverter 7 are accommodated in the housing 6. The fluid O is stored in the housing 6. The pump 8 and the cooler 9 are fixed to the outer side surface of the housing 6.

The motor 2 of the present embodiment is a three-phase AC motor. The motor 2 has both a function as an electric motor and a function as a generator. The motor 2 is located on the other side (−Y side) of the transmission mechanism 3 in the axial direction. The motor 2 includes a rotor 20 arranged to rotate about the first axis (motor axis) J1, which extends in a horizontal direction, and a stator 25 arranged radially outside of the rotor 20. The motor 2 of the present embodiment is an inner rotor type motor in which the rotor 20 is arranged inside the stator 25. The configuration of the motor 2 is not limited to the present embodiment.

The rotor 20 rotates about the first axis J1 extending in the horizontal direction. The rotor 20 includes a motor shaft 21, a rotor core 24 fixed to an outer peripheral surface of the motor shaft 21, and a rotor magnet (not illustrated) fixed to the rotor core.

The motor shaft 21 extends along the axial direction about the first axis J1. The motor shaft 21 rotates about the first axis J1. A first shaft 46 of the transmission mechanism 3 is connected to an end portion of the motor shaft 21 on one side (+Y side) in the axial direction. As a result, a torque of the rotor 20 is transmitted to the transmission mechanism 3. The motor shaft 21 is a hollow shaft. The motor shaft 21 is provided with a hole 21k extending radially outside from a hollow portion 21h. The motor shaft 21 is rotatably supported by the housing 6 via bearings B5 and B6.

The stator 25 is held by the housing 6. The stator 25 surrounds the rotor 20 from the radially outer side. The stator 25 includes a stator core 27 having a substantially annular shape centered on the first axis J1 and a coil 26 attached to the stator core 27. The stator core 27 is fixed to the housing 6.

The coil 26 is attached to each tooth portion of the stator core 27 with an insulator (not illustrated) therebetween. The coil 26 includes a plurality of coil wires. In addition, the coil 26 may be configured by connecting a plurality of rod-shaped conductors. A bus bar 30 is connected to the coil 26. An alternating current is supplied to the coil 26 via the bus bar 30.

The inverter 7 converts direct current supplied from a battery (not illustrated) into alternating current. The inverter 7 is connected to the coil 26 of the stator 25 via the bus bar 30. The inverter 7 supplies power to the motor 2 via the bus bar 30 to control the motor 2.

The transmission mechanism 3 is located on one side (−Y side) of the motor 2 in the axial direction. The transmission mechanism 3 transmits power of the motor 2 to output the power from an output shaft 55. The transmission mechanism 3 includes a first shaft 46, a first gear 41, a second shaft 45, a second gear 42, a third gear 43, a differential device 5, an output shaft 55, and a plurality of bearings B1, B2, B3, B4, and B7.

The first shaft 46 and the first gear 41 are disposed around the first axis J1. The first shaft 46 and the first gear 41 are rotatable about the first axis J1. The first shaft 46 extends in the axial direction of the first axis J1. The end portion on the other side (−Y-side) in the axial direction of the motor shaft 21 is connected to the first shaft 46. The first shaft 46 rotates in synchronization with the motor shaft 21. The first gear 41 is provided on an outer peripheral surface of the first shaft 46. The first gear 41 rotates about the first axis J1 together with the first shaft 46. The first shaft 46 is rotatably supported by the housing 6 via the bearings B1 and B2.

The second shaft 45, the second gear 42, and the third gear 43 are disposed about the second axis J2 parallel to the first axis J1. The second shaft 45, the second gear 42, and the third gear 43 are rotatable about the second axis J2. The second shaft 45 extends along the axial direction of the second axis J2. The second shaft 45 is rotatably supported by the housing 6 the via bearings B3 and B4. The second gear 42 and the third gear 43 are provided on the outer peripheral surface of the second shaft 45. The second gear 42 and the third gear 43 are disposed at intervals in the axial direction. The second gear 42 and the third gear 43 rotate around the second axis J2 together with the second shaft 45. The second gear 42 meshes with the first gear 41. The third gear 43 meshes with a ring gear 51 of the differential device 5 described below.

The differential device 5 includes a ring gear 51, a differential case 50, and a differential mechanism 5a. The differential device 5 is disposed about the third axis J3 parallel to the first axis J1. The differential device 5 is rotatable about the third axis J3. The ring gear 51 meshes with the third gear 43. The ring gear 51 rotates about the third axis J3. The ring gear 51 is fixed to the differential case 50.

The differential case 50 includes a case portion 50b that accommodates the differential mechanism 5a therein, and a third shaft 5b and a fourth shaft 5c. The third shaft 5b protrudes from the outer side surface of the case portion 50b to one side (+Y side) in the axial direction. The fourth shaft 5c protrudes from the outer side surface of the case portion 50b to the other side (−Y side) in the axial direction. The third shaft 5b and the fourth shaft 5c have a cylindrical shape extending along the axial direction about the third axis J3. The output shaft 55 is disposed inside each of the third shaft 5b and the fourth shaft 5c. The third shaft 5b and the fourth shaft 5c rotate together with the ring gear 51 about the third axis J3. The third shaft 5b is rotatably supported by the housing 6 via the bearing B7. The fourth shaft 5c is rotatably supported by the housing 6 via a bearing (not illustrated). That is, the transmission mechanism 3 includes the third shaft 5b and the fourth shaft 5c that are rotatable about the third axis J3.

The differential mechanism 5a is disposed inside the differential case 50. The rotation of the ring gear 51 is transmitted to the differential mechanism 5a via the differential case 50. A pair of output shafts 55 is connected to the differential mechanism 5a. The differential mechanism 5a transfers the torque to the output shafts 55 of the left and right wheels while absorbing a difference in speed between the left and right wheels when the vehicle turns.

The pair of output shafts 55 extends from the differential mechanism 5a to one side and the other side in the axial direction about the third axis J3. The pair of output shafts 55 is rotatably supported by the housing 6 about the third axis J3 via bearings (not illustrated) arranged on the inner peripheral surface of the third shaft 5b or the fourth shaft 5c. A wheel (not illustrated) is connected to each of the pair of output shafts 55.

The torque output from the motor 2 is transmitted to the ring gear 51 of the differential device 5 via the motor shaft 21, the first shaft 46, the first gear 41, the second gear 42, the second shaft 45 and the third gear 43, and further, is transmitted to the wheel via the differential mechanism 5a, and the output shaft 55. In this manner, the transmission mechanism 3 transmits the torque of the motor 2 to the wheels of the vehicle.

The plurality of bearings B1, B2, B3, B4, B5, B6, and B7 are held by the housing 6. The bearings B1 and B2 are arranged around the first axis J1. The bearing B1 supports the end portion of the first shaft 46 on one side (+Y side) in the axial direction, and the bearing B2 supports the end portion of the first shaft 46 on the other side (−Y side) in the axial direction. The bearings B3 and B4 are disposed around the second axis J2. The bearing B3 supports the end portion of the second shaft 45 on one side (+Y side) in the axial direction, and the bearing B4 supports the end portion of the second shaft 45 on the other side (−Y side) in the axial direction. The bearings B5 and B6 are disposed around the first axis J1. The bearing B5 supports the end portion of the motor shaft 21 on one side (+Y side) in the axial direction, and the bearing B6 supports the end portion of the motor shaft 21 on the other side (−Y side) in the axial direction. The bearing B7 is disposed about the third axis J3. The bearing B7 supports the end portion of the third shaft 5b on one side (+Y side) in the axial direction. In the description of the present embodiment, the bearing B1 is referred to as a first bearing, the bearing B3 is referred to as a second bearing, and the bearing B7 is referred to as a third bearing.

The housing 6 is provided with a motor chamber 6A that accommodates the motor 2, a gear chamber 6B that accommodates the transmission mechanism 3, and an inverter chamber 6C that accommodates the inverter 7. The gear chamber 6B is located on one side (+Y side) of the motor chamber 6A in the axial direction. The inverter chamber 6C is located on the upper side (+Z side) of the motor chamber 6A.

The fluid O is stored in the housing 6. The housing 6 is provided with a flow path 90 through which the fluid O flows. That is, the drive device 1 includes the flow path 90 through which the fluid O can flow. The fluid O passes through the flow path 90 and circulates in the housing 6. The fluid O serves as a cooling refrigerant for the motor 2 and a lubricating oil for the transmission mechanism 3. An oil equivalent to a lubricating oil (ATF: Automatic Transmission Fluid) for an automatic transmission having a relatively low viscosity is preferably used as the fluid O in order to perform functions of a lubricating oil and a cooling oil.

The fluid O is accumulated in a lower region inside the housing 6. That is, the fluid O accumulates in the lower region in the housing 6. Hereinafter, the lower region in the housing 6 where the fluid O is stored is referred to as a reservoir P. In the housing 6 of the present embodiment, the bottom surface of the motor chamber 6A and the bottom surface of the gear chamber 6B are substantially aligned in the up-down direction. Therefore, the reservoir P is provided across the lower region of the motor chamber 6A and the lower region of the housing 6.

The ring gear 51 is immersed in the fluid O in the reservoir P. The ring gear 51 lifts up the fluid O in the reservoir P and scatters the fluid O into the gear chamber 6B as the ring gear rotates about the third axis J3. The fluid O scraped up by the ring gear 51 is supplied to each gear in the gear chamber 6B and used for lubrication of a tooth surface or the like of the gear.

The fluid O in the reservoir P passes through the flow path 90 and is sent to the upper region of the motor chamber 6A and the upper region of the gear chamber 6B. The fluid O sent to the upper region of the motor chamber 6A drops into the reservoir P in the lower region of the motor chamber 6A after cooling the motor 2 along the surface of the motor 2. The fluid O sent to the upper region of the gear chamber 6B lubricates each gear of the transmission mechanism 3 and a bearing supporting the transmission mechanism 3, and then returns to the reservoir P in the lower region of the gear chamber 6B.

The housing 6 is configured by combining a plurality of members. The housing 6 includes a housing body (first member) 61, a motor cover 63 located on the other side (−Y side) in the axial direction of the housing body 61, a gear cover (second member) 62 located on one side (+Y side) in the axial direction of the housing body 61, and an inverter cover 64 located on the upper side (+Z side) of the housing body 61.

The housing body 61 includes a partition wall 65, a first cylindrical portion 61a, a second cylindrical portion 61b, and a box-shaped portion 61c. The partition wall 65 extends along a plane orthogonal to the first axis J1. The first cylindrical portion 61a protrudes from the partition wall 65 to the other side (−Y side) in the axial direction. The first cylindrical portion 61a has a cylindrical shape surrounding the first axis J1. The second cylindrical portion 61b protrudes from the partition wall 65 to one side (+Y side) in the axial direction. The second cylindrical portion 61b has a cylindrical shape surrounding the first axis J1, the second axis J2, and the third axis J3. The box-shaped portion 61c has a box shape that is open upward with a part of the outer side surface of the first cylindrical portion 61a as a bottom surface. The opening of the box-shaped portion 61c is covered by the inverter cover 64. The inverter chamber 6C is provided in a space surrounded by the inner side surface of the box-shaped portion 61c and the inverter cover 64.

The partition wall 65 partitions the motor chamber 6A and the gear chamber 6B. The partition wall 65 is provided with a shaft insertion hole 65c and a partition wall opening 65b. The shaft insertion hole 65c and the partition wall opening 65b pass through the partition wall 65 in the axial direction. The shaft insertion hole 65c and the partition wall opening 65b connect the motor chamber 6A and the gear chamber 6B, and allow them to communicate with each other. The inner side surface of the shaft insertion hole 65c supports the motor shaft 21 and the first shaft 46 via bearings B5 and B2. In the present embodiment, the motor shaft 21 and the first shaft 46 are connected to each other inside the shaft insertion hole 65c. However, the motor shaft 21 and the first shaft 46 may be connected to each other outside the shaft insertion hole 65c. The partition wall opening 65b is positioned below the shaft insertion hole 65c. The partition wall opening 65b constitutes a flow path of the fluid O flowing from the motor chamber 6A to the gear chamber 6B.

The motor cover 63 has a plate shape extends along a plane orthogonal to the first axis J1. The motor cover 63 covers the opening on the other side (−Y side) in the axial direction of the first cylindrical portion 61a. The motor chamber 6A is provided in a space radially inside the first cylindrical portion 61a, on the other side (−Y side) in the axial direction of the partition wall 65, and on one side (+Y side) in the axial direction of the motor cover 63.

The gear cover 62 has a concave shape that is open to the other side (−Y side) in the axial direction. The gear cover 62 includes a plate-shaped side wall 62w extending along a plane orthogonal to the first axis J1 and a third cylindrical portion 62b protruding from the side wall 62w to the other side (−Y side) in the axial direction. The gear cover 62 covers an opening on one side (+Y side) in the axial direction of the second cylindrical portion 61b. An end surface on the other side (−Y side) in the axial direction of the third cylindrical portion 62b is connected to an end surface on one side (+Y side) in the axial direction of the second cylindrical portion 61b. The gear chamber 6B is provided in a space radially inside the second cylindrical portion 61b and the third cylindrical portion 62b, on one side (+Y side) in the axial direction of the partition wall 65, and on the other side (−Y side) in the axial direction of the side wall 62w. That is, the side wall 62w covers the gear chamber 6B from one side (+Y side) in the axial direction.

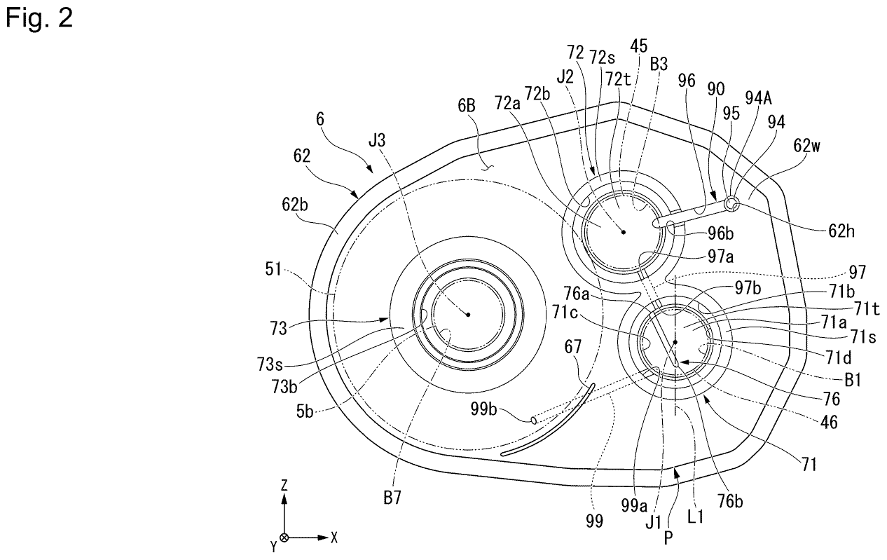

FIG. 2 is a front view of the side wall 62w according to the drive device 1 of the present embodiment.

The side wall 62w is provided with a first bearing holding portion 71, a second bearing holding portion 72, and a third bearing holding portion 73. That is, the housing 6 includes the first bearing holding portion 71, the second bearing holding portion 72, and the third bearing holding portion 73.

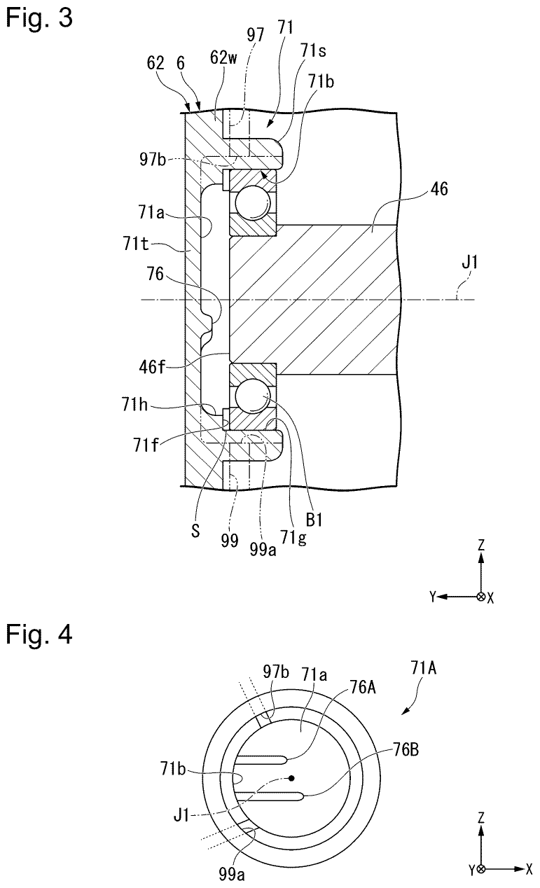

FIG. 3 is a schematic cross-sectional view of the first bearing holding portion 71.

The first bearing holding portion 71 includes a first cylindrical portion (first wall) 71s and a first facing wall 71t. The first cylindrical portion 71s has a substantially cylindrical shape centered on the first axis J1. The first cylindrical portion 71s surrounds the first bearing B1 from the radially outer side of the first axis J1. The first facing wall 71t extends along a plane orthogonal to the first axis J1. The first facing wall 71t is a part of the side wall 62w, and is a region surrounded by the first cylindrical portion 71s when viewed from the axial direction.

The first facing wall 71t has a first facing surface 71a facing the other side (−Y side) in the axial direction. The first facing surface 71a extends in a direction orthogonal to the axial direction. The first facing surface 71a is located on one side in the axial direction with respect to an end portion on one side (+Y side) in the axial direction of the first shaft 46. The first facing surface 71a faces the end surface 46f on one side in the axial direction of the first shaft 46 in the axial direction. The first facing surface 71a is provided with a first rib 76. The first rib 76 protrudes from the first facing surface 71a to the other side (−Y side) in the axial direction. The first rib 76 extends in a direction orthogonal to the axial direction. The first rib 76 will be described in detail later.

The first cylindrical portion 71s has a first inner side surface 71b. The first inner side surface 71b includes a stepped surface 71f facing the other side (−Y side) in the axial direction, a large diameter portion 71g located on the other side in the axial direction with respect to the stepped surface 71f, and a small diameter portion 71h located on one side in the axial direction with respect to the stepped surface 71f. The stepped surface 71f has a substantially annular shape when viewed from the axial direction. The stepped surface 71f supports the first bearing B1 from one side (+Y side) in the axial direction. A shim S having a substantially annular plate shape is disposed between the stepped surface 71f and the first bearing B1 in the axial direction.

The large diameter portion 71g is a cylindrical radially inner side surface extending in the axial direction with the first axis J1 as the center. The large diameter portion 71g extends from the outer edge of the stepped surface 71f to the other side (−Y side) in the axial direction. The large diameter portion 71g surrounds the outer side surface of the first bearing B1 from the radially outer side. The first inner side surface 71b supports the first bearing B1 from the radial outside about the first axis J1 in the large diameter portion 71g.

The small diameter portion 71h extends from the inner edge of the stepped surface 71f to one side (+Y side) in the axial direction. The small diameter portion 71h is connected to the first facing surface 71a. That is, the first inner side surface 71b extends from the first facing surface 71a to the other side (−Y side) in the axial direction in the small diameter portion 71h. The small diameter portion 71h is a cylindrical surface extending in the axial direction about the first axis J1. The small diameter portion 71h has a smaller inner diameter than the large diameter portion 71g.

As illustrated in FIG. 2, the second bearing holding portion 72 includes a second cylindrical portion (second wall) 72s and a second facing wall 72t. The second cylindrical portion 72s has a cylindrical shape centered on the second axis J2. The second cylindrical portion 72s surrounds the second bearing B3 from the radially outer side of the second axis J2. As illustrated in FIG. 1, the second cylindrical portion 72s has a second inner side surface 72b. The second inner side surface 72b supports the second bearing B3 from the radial outside about the second axis J2. The second cylindrical portion 72s has substantially the same configuration as the first cylindrical portion 71s described above. That is, the second inner side surface 72b is provided with a stepped portion, a large diameter portion, and a small diameter portion similar to those of the first inner side surface 71b.

The second facing wall 72t extends along a plane orthogonal to the second axis J2. The second facing wall 72t is a part of the side wall 62w, and is a region surrounded by the second cylindrical portion 72s when viewed from the axial direction. The second facing wall 72t has a second facing surface 72a facing the other side (−Y side) in the axial direction. The second facing surface 72a extends in a direction orthogonal to the axial direction. The second facing surface 72a is located on one side in the axial direction with respect to the end portion on one side (+Y side) in the axial direction of the second shaft 45. The second facing surface 72a faces the end surface on one side in the axial direction of the second shaft 45 in the axial direction. The second facing surface 72a is connected to the second inner side surface 72b. That is, the second inner side surface 72b extends from the second facing surface 72a to the other side (−Y side) in the axial direction.

As illustrated in FIG. 2, the third bearing holding portion 73 has a third cylindrical portion (third wall) 73s. The third cylindrical portion 73s has a substantially cylindrical shape centered on the third axis J3. The third cylindrical portion 73s surrounds the third bearing B7 from the radially outer side of the third axis J3. The third cylindrical portion 73s extends from the side wall 62w to the other side (−Y side) in the axial direction. The third cylindrical portion 73s has a third inner side surface 73b. The third inner side surface 73b supports the third bearing B7 from the radial outside about the third axis J3. The third cylindrical portion 73s has substantially the same configuration as the first cylindrical portion 71s described above. That is, the third inner side surface 73b is provided with a stepped portion, a large diameter portion, and a small diameter portion similar to those of the first inner side surface 71b.

As illustrated in FIG. 2, the gear chamber 6B is provided with a guide wall 67 extending in a curved manner along the tooth tip of the ring gear 51. In the present embodiment, the guide wall 67 is a rib protruding from the side wall 62w to the other side (−Y side) in the axial direction. The guide wall 67 extends in a substantially arc shape about the third axis J3. The guide wall 67 is curved along the tooth tip of the ring gear 51. The guide wall 67 guides the fluid O in the reservoir P in the circumferential direction around the third axis J3 along the tooth tip of the ring gear 51 by the surface facing the radial inside of the third axis J3. By providing the guide wall 67, the ring gear 51 can efficiently scrape up the fluid O. Note that the guide wall 67 may be a member separate from the side wall 62w. The partition wall 65 may be provided as a rib protruding to one side in the axial direction. The guide wall 67 may be configured by combining a rib provided on the side wall 62w and protruding to the other side (−Y side) in the axial direction and a rib provided on the partition wall 65 and protruding to one side (+Y side) in the axial direction.

The flow path 90 illustrated in FIG. 1 is a circulation path through which the fluid O flows. That is, the fluid O flows through the flow path 90 provided in the housing 6. At least a part of the flow path 90 may be provided in the housing 6. The flow path 90 is a path of the fluid O that is fed to the fluid O from the fluid reservoir P to the motor 2 and the transmission mechanism 3. In the present specification, the concept of the “flow path” is not only a path that constantly generates a flow of the fluid O directed in one direction, but also a path that temporarily retains the fluid O and a path in which the fluid O drips.

The pump 8, the cooler 9, the first supply pipe 93A, and the second supply pipe 94A are disposed in the flow path 90. The first supply pipe 93A and the second supply pipe 94A are disposed inside the housing 6.

The pump 8 sucks and pressure-feeds the fluid O from the reservoir P of the gear chamber 6B. The pump 8 supplies the fluid O to the motor 2 and the transmission mechanism 3. In the present embodiment, the pump 8 is an electric pump driven by electricity.

The cooler 9 cools the fluid O in the flow path 90. A refrigerant (not illustrated) flows inside the oil cooler 9. The cooler 9 is a heat exchanger that transfers the heat of fluid O to the refrigerant. The fluid O pumped from the pump 8 flows into the cooler 9. The flowed fluid O is cooled by heat exchange with the refrigerant in the cooler 9. The refrigerant is separately cooled by a radiator (not illustrated).

The first supply pipe 93A is disposed in the motor chamber 6A. In the present embodiment, two first supply pipes 93A are provided. The two first supply pipes 93A extend along the axial direction on the radially outer side of the stator 25. The end portion on one side (+Y side) in the axial direction of the first supply pipe 93A is supported by the partition wall 65, and the end portion on the other side (−Y side) in the axial direction is supported by the motor cover 63. The first supply pipe 93A is provided with a plurality of ejection holes 93k opened toward the stator 25. The number of first supply pipes 93A is not limited to two. For example, one first supply pipe 93A may be provided, or three or more first supply pipes may be provided.

The second supply pipe 94A is disposed in the gear chamber 6B. The second supply pipe 94A extends along the axial direction. The end portion on one side (+Y side) in the axial direction of the second supply pipe 94A is supported by the gear cover 62, and the end portion on the other side (−Y side) in the axial direction is supported by the partition wall 65. The second supply pipe 94A of the present embodiment is arranged side by side with the first supply pipe 93A in the axial direction. The second supply pipe 94A is provided with a plurality of ejection holes 94k opened toward the transmission mechanism 3. The first supply pipe 93A and the second supply pipe 94A may not be arranged side by side in the axial direction.

The flow path 90 of the present embodiment includes a suction flow path portion 91, a first pressure feed flow path portion 91A, a second pressure feed flow path portion 92, a third pressure feed flow path portion 93, a fourth pressure feed flow path portion 94, a supply flow path portion 96, a communication flow path portion 97, and a terminal flow path portion 99. The third pressure feed flow path portion 93 and the fourth pressure feed flow path portion 94 are flow paths passing through the inside of the first supply pipe 93A and the second supply pipe 94A, respectively.

The suction flow path portion 91 is a flow path connecting the reservoir P and the pump 8. The first pressure feed flow path portion 91A extends from the pump 8 to the motor cover 63. The cooler 9 is disposed in the path of the first pressure feed flow path portion 91A. The second pressure feed flow path portion 92 is provided in the motor cover 63. The second pressure feed flow path portion 92 is connected to the first pressure feed flow path portion 91A at the upstream end portion. The second pressure feed flow path portion 92 branches into two on the way, is connected to the hollow portion 21h of the motor shaft 21 through a first branch path, and is connected to the first supply pipe 93A through a second branch path. Part of the fluid O flowing into the second pressure feed flow path portion 92 flows into the hollow portion 21h and the first supply pipe 93A. Part of the fluid O supplied to the hollow portion 21h is supplied to the bearings B5 and B6 supporting the motor shaft 21 to lubricate the bearings B5 and B6. The other part of the fluid O supplied to the hollow portion 21h passes through the hole 21k by centrifugal force, scatters radially outside from the rotor 20, and is supplied to the stator 25.

The fluid O supplied to the first supply pipe 93A flows through the third pressure feed flow path portion 93 provided inside the first supply pipe 93A. Part of the fluid O flowing through the third pressure feed flow path portion 93 is supplied to the motor 2 via the ejection hole 93k. The downstream end portion of the third pressure feed flow path portion 93 is connected to the fourth pressure feed flow path portion 94. The fourth pressure feed flow path portion 94 is provided inside the second supply pipe 94A. Part of the fluid O flowing into the fourth pressure feed flow path portion 94 is supplied to the transmission mechanism 3 via the ejection hole 94k.

As illustrated in FIG. 2, the side wall 62w of the gear cover 62 is provided with a support recess 62h into which the end portion on one side (+Y side) in the axial direction of the second supply pipe 94A is inserted. The end portion on one side (+Y side) in the axial direction of the second supply pipe 94A functions as a feed portion 95 that supplies the fluid O to the gear chamber 6B. That is, the flow path 90 includes the feed portion 95 that supplies the fluid O to the gear chamber 6B.

The supply flow path portion 96 is a groove provided on a surface facing the other side (−Y side) in the axial direction of the side wall 62w. The supply flow path portion 96 extends linearly when viewed from the axial direction. The supply flow path portion 96 extends from the support recess 62h to the inside of the second bearing holding portion 72. The fluid O flowing out from the end portion of the second supply pipe 94A reaches the inside of the second bearing holding portion 72 through the supply flow path portion 96 and lubricates the second bearing B3. The supply flow path portion 96 may be a hole provided inside the side wall 62w.

The communication flow path portion 97 is a hole portion connecting the inside of the second bearing holding portion 72 and the inside of the first bearing holding portion 71. In the present exemplary embodiment, the communication flow path portion 97 extends linearly over the entire length. The fluid o inside the second bearing holding portion 72 reaches the inside of the first bearing holding portion 71 through the communication flow path portion 97 and lubricates the bearing B1. Note that the communication flow path portion 97 may not extend linearly over the entire length. For example, it may be bent or curved.

According to the present embodiment, the flow path 90 includes the communication flow path portion 97 connecting the second bearing holding portion 72 and the first bearing holding portion 71. As a result, part of the fluid O can be supplied to the second bearing holding portion 72 to lubricate the second bearing B3, and the other part can move to the first bearing holding portion 71 to lubricate the first bearing B1. According to the flow path 90 of the present embodiment, the fluid O can be supplied to the plurality of bearings B1 and B3, and seizure of these bearings B1 and B3 can be suppressed.

The terminal flow path portion 99 is a hole portion provided in the side wall 62w. In the present embodiment, the terminal flow path portion 99 extends linearly over the entire length. The terminal flow path portion 99 connects the first inner side surface 71b and an opening end 99b opened in the lower region of the gear chamber 6B. That is, the terminal flow path portion 99 has the opening end 99b opened to the gear chamber 6B. The opening end 99b is located at the lower end of the terminal flow path portion 99. The opening end 99b is disposed closer to the ring gear 51 than the guide wall 67 in the first direction (X-axis direction). The opening end 99b of the present embodiment overlaps the ring gear 51 when viewed from the axial direction. The terminal flow path portion 99 may not extend linearly over the entire length. For example, it may be bent or curved.

When the drive device 1 is driven, the fluid level of the fluid O may decrease in a region around the ring gear 51 and on the other side (−X side) in the second direction with respect to the guide wall 67 due to the fluid O being scraped up by the ring gear 51. In this case, the amount of the fluid O scraped up by the ring gear 51 decreases, and the amount of the fluid O supplied to each gear in the gear chamber 6B may be insufficient. According to the present embodiment, since the fluid O is supplied to the periphery of the ring gear 51 via the terminal flow path portion 99, it is possible to suppress a decrease in the liquid level of the fluid O around the ring gear 51. As a result, it is possible to secure the scraping amount of the ring gear 51 and suppress the shortage of the supply amount of the fluid O to each gear.

The first bearing holding portion 71 and the second bearing holding portion 72 are disposed on the upstream side of the terminal flow path portion 99 of the present embodiment. Therefore, the fluid O flowing through the terminal flow path portion 99 is the fluid O that lubricates the bearings B1 and B3. The fluid O flowing through the terminal flow path portion 99 flows from the first bearing holding portion 71 to the second bearing holding portion 72. According to the flow path 90 of the present embodiment, the fluid O can be supplied to the bearings B1 and B3 before being supplied to the periphery of the ring gear 51 via the terminal flow path 99. Therefore, it is possible to effectively suppress seizure of the bearings B1 and B3.

On the second inner side surface 72b, an inflow portion 96b and an outflow portion 97a are opened. That is, the flow path 90 has the inflow portion 96b and the outflow portion 97a. The inflow portion 96b is located at the lower end portion of the supply flow path portion 96. The outflow portion 97a is positioned below the inflow portion 96b. The outflow portion 97a is positioned at an upper end of the communication flow path portion 97. The fluid O flows into the second bearing holding portion 72 from the inflow portion 96b. Further, the fluid O flows out from the second bearing holding portion 72 via the outflow portion 97a.

On the first inner side surface 71b, a first inflow portion 97b and a first outflow portion 99a are opened. That is, the flow path 90 has the first inflow portion 97b and the first outflow portion 99a. The first inflow portion 97b is located at the lower end of the communication flow path portion 97. The first outflow portion 99a is positioned below the first inflow portion 97b. The first outflow portion 99a is located at the upper end of the terminal flow path portion 99. The fluid O flows into the first bearing holding portion 71 from the first inflow portion 97b. Further, the fluid O flows out from the first bearing holding portion 71 via the first outflow portion 99a.

The first rib 76 is disposed inside the first bearing holding portion 71. The first rib 76 extends linearly over the entire length when viewed from the axial direction. The first rib 76 has a first end portion 76a and a second end portion 76b. The first end portion 76a is located above the second end portion 76b. The first end portion 76a is connected to the first inner side surface 71b. The first end portion 76a is located near the first inflow portion 97b and below the first inflow portion 97b. The first end portion 76a is located above the first outflow portion 99a. The first rib 76 guides the fluid O flowing from the first inner side surface 71b toward the second end portion 76b at the first end portion 76a.

According to the present embodiment, since the first outflow portion 99a is provided in the first bearing holding portion 71, part of the fluid O supplied to the first bearing holding portion 71 can be supplied to the other portion (for example, the circumference of the ring gear 51) via the first outflow portion 99a.

At least a part of the first rib 76 of the present embodiment is located below the first inflow portion 97b. At least a part of the first rib 76 of the present embodiment covers the first outflow portion 99a from above. Since at least a part of the first rib 76 is located below the first inflow portion 97b, the fluid O flowing into the first bearing holding portion 71 from the first inflow portion 97b is received by the first rib 76. That is, according to the present embodiment, the first rib 76 prevents the fluid O from being directly guided to the first outflow portion 99a. Since at least a part of the first rib 76 covers the first outflow portion 99a from above, the fluid O in the first bearing holding portion 71 is prevented from immediately reaching the first outflow portion 99a. That is, according to the present embodiment, by providing the first rib 76, the path from the first inflow portion 97b to the first outflow portion 99a becomes long. According to the present embodiment, the first rib 76 can suppress the fluid O flowing into the first bearing holding portion 71 from immediately flowing out toward the third cylindrical portion 73s via the first outflow portion 99a. Since the time during which the fluid O flows in the first bearing holding portion 71 becomes long, the fluid O is easily supplied to the first bearing B1. Part of the fluid O flowing along the first rib 76 is supplied to the first bearing B1 in the process of flowing from the first rib 76 to the other side (−Y side) in the axial direction. Therefore, by providing the first rib 76, more fluid O can be supplied to the first bearing B1.

In the present specification, “covering from above” means that a portion is located above the target portion and overlaps at least a part of the target portion when viewed from the vertical direction. Therefore, at least a part of the first rib 76 of the embodiment is located above the first outflow portion 99a and overlaps at least a part of the first outflow portion 99a when viewed from the vertical direction.

Here, as illustrated in FIG. 2, a first dividing line L1 passing through the first axis J1 and extending in the vertical direction when viewed from the axial direction is assumed. The first inner side surface 71b has a first portion 71c and a second portion 71d partitioned by the first dividing line L1. Each of the first portion 71c and the second portion 71d is a part of the first inner side surface 71b, and extends in a substantially semicircular shape when viewed from the axial direction. The first portion 71c is located on the other side (−X side) in the first direction with respect to the first dividing line L1. The second portion 71d is located on one side (+X side) in the first direction with respect to the first dividing line L1. The first portion 71c and the second portion 71d face each other across the first axis J1.

In the present embodiment, the first inflow portion 97b is open in the first portion 71c. The first outflow portion 99a is open to the first portion 71c. That is, the first inflow portion 97b and the first outflow portion 99a are open to the first portion 71c which is the same region among the two regions partitioned by the first dividing line L1. Further, the first rib 76 is connected to the first portion 71c below the first inflow portion 97b. As described above, the first rib 76 covers the first outflow portion 99a from above. Therefore, the first end portion 76a of the first rib 76 is connected to the first portion 71c between the first inflow portion 97b and the first outflow portion 99a.

In the present embodiment, both the first inflow portion 97b and the first outflow portion 99a are open to the first portion 71c. In a case where the first inflow portion 97b and the first outflow portion 99a are disposed in this manner, if the first rib 76 is not provided, the fluid O flowing into the first bearing holding portion 71 from the first inflow portion 97b flows downward along the first portion 71c and flows out from the first outflow portion 99a in a path reaching the lower end of the first inner side surface 71b. Therefore, in this case, the fluid O is less likely to accumulate at the lower end of the first bearing holding portion 71. On the other hand, according to the present embodiment, the first rib 76 is connected to the first portion 71c along which the fluid O flows. Therefore, at least a part of the fluid O flowing downward along the first portion 71c is accumulated at the lower end of the first inner side surface 71b along the first rib 76. As a result, it is possible to suppress the fluid O from immediately flowing out from the inside of the first bearing holding portion 71 to the third cylindrical portion 73s side via the first outflow portion 99a, and the fluid O is easily supplied to the first bearing B1.

In addition, the first rib 76 of the present embodiment extends in the first direction (X-axis direction) beyond the first dividing line L1. That is, the first end portion 76a is disposed on the first portion 71c side with respect to the first dividing line L1, and the second end portion 76b is disposed on the second portion 71d side with respect to the first dividing line L1. The first rib 76 of the present embodiment can detour the fluid O flowing from the inner side surface 71b in the first portion 71c toward the second portion 71d, and can more easily accumulate the fluid O at the lower end of the first inner side surface 71b. Therefore, the fluid O is easily supplied to the bearing B1.

In the present embodiment, the first end portion 76a of the first rib 76 is connected to the first inner side surface 71b. As a result, the fluid O flowing along the first inner side surface 71b is easily guided to the surface of the first rib 76. However, the first rib 76 is not necessarily connected to the first inner side surface 71b. The first rib 76 may be connected to the first inner side surface 71b not only at the first end portion 76a but also at the second end portion 76b.

The fluid O in the flow path 90 of the present embodiment is pumped by the pump 8. The pump 8 of the present embodiment is an electrically controlled electric pump. Therefore, the pump 8 can stably supply the fluid O to each of the bearings B1 and B3 regardless of the driving state of the transmission mechanism 3 as compared with the case of a mechanical pump that is driven in conjunction with the operation of the transmission mechanism 3. Specifically, for example, when insufficient lubrication of the bearings B1 and B3 is concerned, such as when the drive device 1 is not driven for a long period of time, the pump 8 can be driven in advance before the motor 2 is driven, and the fluid O can be supplied to the gear chamber 6B. Accordingly, the bearings B1 and B3 and the transmission mechanism 3 can be lubricated.

A first bearing holding portion of a modification that can be employed in the drive device of the first embodiment will be described. In the description of each modification described below, the same reference numerals are given to the same components as those of the embodiment or modification described above, and the description thereof will be omitted.

FIG. 4 is a schematic view of a first bearing holding portion 71A of a first modification.

The first bearing holding portion 71A of the present modification has a first facing surface 71a and a first inner side surface 71b as in the above-described embodiment. In the present modification, the first facing surface 71a is provided with a plurality of (two in the present modification) first ribs 76A and 76B. The plurality of first ribs 76A and 76B linearly extend over the entire length when viewed from the axial direction. At least a part of each of the plurality of first ribs 76A and 76B is located below the first inflow portion 97b. At least a part of each of the plurality of first ribs 76A and 76B covers the first outflow portion 99a from above.

According to the present modification, the fluid O flowing from the first inflow portion 97b into the first bearing holding portion 71A can be received by the plurality of first ribs 76A and 76B, and the time during which the fluid O flows in the first bearing holding portion 71A can be further lengthened. Therefore, the fluid O is easily supplied to the bearing B1. In addition, the fluid O can be easily accumulated at the lower end of the first inner side surface 71b, and the fluid O can be easily supplied to the bearing B1.

The two first ribs 76A and 76B are connected to the first inner side surface 71b. In the present embodiment, of the two first ribs 76A and 76B, the length of the first rib 76B located on the lower side is longer than the length of the first rib 76A located on the upper side. The first rib 76B located on the lower side is disposed on the lower side with respect to the entire length of the first rib 76A located on the upper side. That is, the entire length of the upper first rib 76A overlaps the lower first rib 76B when viewed in the vertical direction (Z-axis direction). According to the present modification, the fluid O flowing down from the upper first rib 76A to the lower side can be received by the lower first rib 76B. As a result, the time during which the fluid O flows through the first bearing holding portion 71A can be further increased. The length of the first rib 76A located on the upper side may be longer than the length of the first rib 76B located on the lower side. In this case, the entire length of the lower first rib 76B overlaps the upper first rib 76A when viewed in the vertical direction (Z-axis direction). The length of the first rib 76A may be the same as the length of the first rib 76B.

In the present modification, the case where the first bearing holding portion 71A includes the two first ribs 76A and 76B has been described, but the number of first ribs may be three or more as long as the number is plural. In the present modification, the plurality of first ribs 76A and 76B extend in parallel to the first direction (X-axis direction). However, the first ribs 76A and 76B may extend in directions different from each other. The shape of the first rib 76A may be different from that of the second rib 76B. The axial height of the first rib 76A may be different from or the same as the axial height of the second rib 76B. A width of the first rib 76A in the Z axis direction may be different from or equal to a width of the second rib 76B in the Z axis direction.

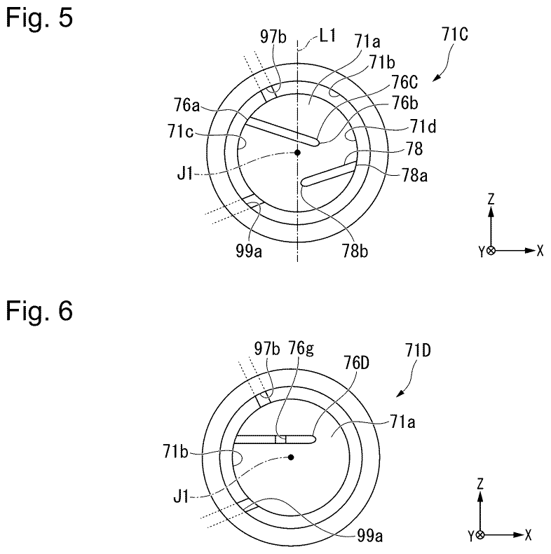

FIG. 5 is a schematic view of a first bearing holding portion 71C of a second modification.

The first bearing holding portion 71C of the present modification has a first facing surface 71a and a first inner side surface 71b as in the above-described embodiment. In the present modification, the first facing surface 71a is provided with a first rib 76C and a third rib 78. The first rib 76C and the third rib 78 protrude from the first facing surface 71a to the other side (−Y side) in the axial direction and extend in a direction orthogonal to the axial direction. The first rib 76C and the third rib 78 extend linearly over the entire length when viewed from the axial direction. As in the above-described embodiment, at least a part of the first rib 76C is located below the first inflow portion 97b, and at least a part covers the first outflow portion 99a from above.

The first rib 76C has a first end portion 76a connected to the first portion 71c and a second end portion 76b radially facing the second portion 71d with a gap interposed therebetween. The second end portion 76b is located below the first end portion 76a. The first rib 76C receives the fluid O flowing in from the first inflow portion 97b at the first end portion 76a and guides the fluid O toward the second end portion 76b.

The third rib 78 has a third end portion 78a connected to the second portion 71d and a fourth end portion 78b radially facing the first portion 71c with a gap interposed therebetween. The fourth end portion 78b is disposed immediately below the first rib 76C. That is, the fourth end portion 78b is located below the first rib 76C and overlaps the first rib 76C when viewed in the vertical direction (Z-axis direction). The fourth end portion 78b is located below the third end portion 78a.

The position of the second end portion 76b of the first rib 76C in the up-down direction is different from the position of the fourth end portion 78b in the up-down direction. The third rib 78 receives the fluid O flowing downward from the first rib 76C and guides the fluid O toward the second end portion 76b. According to the present modification, by causing the fluid O to flow on the surfaces of the first rib 76C and the third rib 78, the time during which the fluid O flows in the first bearing holding portion 71A can be further lengthened. Therefore, the fluid O is easily supplied to the bearing B1. In the present modification, the case where the second end portion 76b is located above the fourth end portion 78b has been described. However, the second end portion 76b may be located below the fourth end portion 78b. In this case, the first rib 76C receives the fluid O flowing downward from the third rib 78. The shape of the first rib 76C may be different from the shape of the third rib 78. The axial height of the first rib 76C may be different from or the same as the axial height of the third rib 78. The width of the first rib 76C in the Z axis direction may be different from or the same as the width of the third rib 78 in the Z axis direction.

FIG. 6 is a schematic view of a first bearing holding portion 71D of a third modification.

The first bearing holding portion 71D of the present modification has a first facing surface 71a and a first inner side surface 71b as in the above-described embodiment. The first facing surface 71a is provided with a first rib 76D. As in the above-described embodiment, at least a part of the first rib 76D is located below the first inflow portion 97b, and at least a part covers the first outflow portion 99a from above.

The first rib 76D of the present modification is provided with a notch 76g recessed from the end portion on the other side (−Y side) in the axial direction to the one side (+Y side) in the axial direction. According to the present modification, part of the fluid O flowing along the first rib 76D flows downward from the notch 76g. According to the present modification, the fluid O can be appropriately sent from the first rib 76D to the first outflow portion 99a, and the fluid O can be stably supplied to the downstream side of the first outflow portion 99a. The width of the notch 76g in the X-axis direction may be constant in the up-down direction, and may gradually increase or decrease. The axial depth of the notch 76g may be constant or different in the up-down direction.

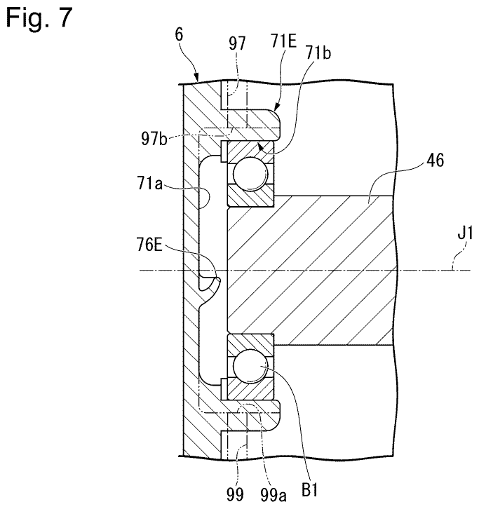

FIG. 7 is a cross-sectional view of a first bearing holding portion 71E of a fourth modification.

The first bearing holding portion 71E of the present modification has a first facing surface 71a and a first inner side surface 71b as in the above-described embodiment. The first facing surface 71a is provided with a first rib 76E. As in the above-described embodiment, at least a part of the first rib 76E is located below the first inflow portion 97b, and at least a part covers the first outflow portion 99a from above.

The first rib 76E protrudes from the first facing surface 71a to the other side (−Y side) in the axial direction. The first rib 76E of the present modification is inclined upward toward the other side (−Y side) in the axial direction. Therefore, the fluid O is accumulated between the first rib 76E and the first facing surface 71a in the axial direction. According to the first rib 76E of the present modification, the fluid O flowing from the first inflow portion 97b can be held, and the time during which the fluid O flows in the first bearing holding portion 71E can be lengthened. Therefore, the fluid O is easily supplied to the bearing B1. The first rib 76E may extend straight or may extend in a curved manner toward the other side (−Y side) in the axial direction. The length of the first rib 76E in the X axis direction is shorter than the inner diameter of the first facing wall 71t.

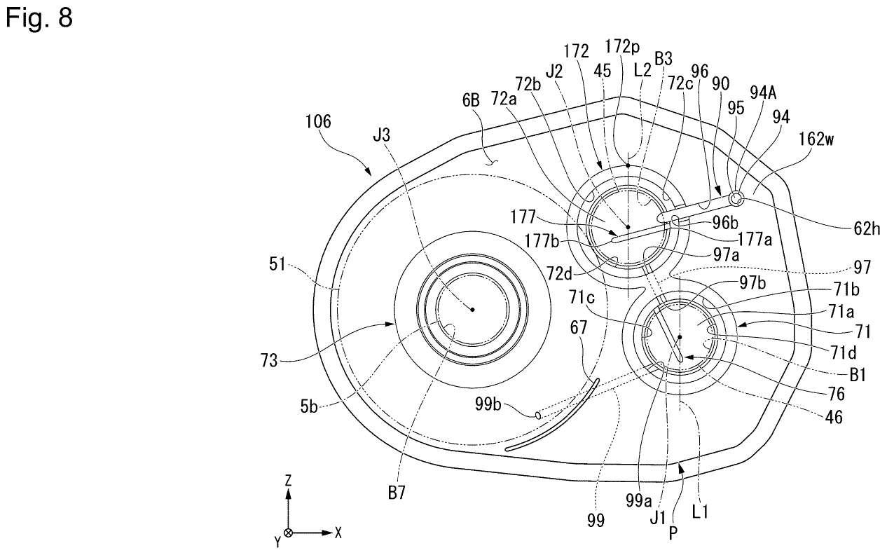

FIG. 8 is a front view of a side wall 162w according to the drive device of the second embodiment. The side wall 162w of the present embodiment is different from the above-described embodiment mainly in that ribs are provided in both a first bearing holding portion 172 and a second bearing holding portion 71.

Note that members or portions that have their equivalents in the above-described embodiment are denoted by the same reference numerals as those of their equivalents in the above-described embodiment, and descriptions of those members or portions are omitted. A first shaft 45 of the present embodiment has the same configuration as the second shaft 45 of the first embodiment. A second shaft 46 of the present embodiment has the same configuration as the first shaft 46 of the first embodiment. The first bearing B3 of the present embodiment has the same configuration as the second bearing B3 of the first embodiment. The second bearing B1 of the present embodiment has the same configuration as the first bearing B1 of the first embodiment. The second bearing holding portion 71 of the present embodiment has the same configuration as the first bearing holding portion 71 of the first embodiment. In addition, the first bearing holding portion 172 of the present embodiment has the same configuration as that of the second bearing holding portion 72 of the first embodiment except that it has a first rib 177.

The side wall 162w is provided with a first bearing holding portion 172, a second bearing holding portion 71, and a third bearing holding portion 73. The side wall 162w is provided with the feed portion 95, the supply flow path portion 96, the communication flow path portion 97, and the terminal flow path portion 99 of the flow path 90.

The first bearing holding portion 172 has a first facing surface 72a and a first inner side surface 72b as in the above-described embodiment. On the first inner side surface 72b, a first inflow portion 96b and a first outflow portion 97a are open. That is, the flow path 90 has the first inflow portion 96b and the first outflow portion 97a. The fluid O flows into the first bearing holding portion 172 from the first inflow portion 96b. Further, the fluid O flows out from the first bearing holding portion 172 via the first outflow portion 97a.

The first facing surface 72a is provided with a first rib 177. The first rib 177 protrudes from the first facing surface 72a to the other side (−Y side) in the axial direction. The first rib 177 extends in a direction orthogonal to the axial direction. The first rib 177 extends linearly over the entire length when viewed from the axial direction. The first rib 177 has a first end portion 177a and a second end portion 177b. The first end portion 177a is located above the second end portion 177b. The first end portion 177a is connected to the first inner side surface 72b. The first end portion 177a is located near the first inflow portion 96b and below the first inflow portion 96b. The first end portion 177a is located above the first outflow portion 97a. The first rib 177 guides the fluid O flowing from the first inner side surface 72b toward the second end portion 177b at the first end portion 177a.

At least a part of the first rib 177 of the present embodiment is located below the first inflow portion 96b, and at least a part covers the first outflow portion 97a from above. According to the present embodiment, the path from the first inflow portion 96b to the first outflow portion 97a is lengthened by the first rib 177. As a result, the first rib 177 can suppress the fluid O flowing into the first bearing holding portion 172 from immediately flowing out to the outside via the first outflow portion 97a. The fluid O is more easily accumulated at the lower end of the first inner side surface 72b, and the fluid O is easily supplied to the first bearing B3. In addition, since the fluid O is supplied to the first bearing B3 when flowing along the first rib 177, more fluid can be supplied to the first bearing B3.

As illustrated in FIG. 8, a first dividing line L2 that passes through the first axis J2 (the second axis of the first embodiment) and extends in the vertical direction when viewed from the axial direction is assumed.

The first inner side surface 72b has a first portion 72c and a second portion 72d partitioned by a first dividing line L2. Each of the first portion 72c and the second portion 72d is a part of the first inner side surface 72b, and extends in a substantially semicircular shape when viewed from the axial direction. The first portion 72c is located on one side (+X side) in the second direction with respect to the first dividing line L2. The second portion 72d is located on the other side (−X side) in the second direction with respect to the first dividing line L2. In the present embodiment, the first inflow portion 96b and the first outflow portion 97a are open to the first portion 72c. The first rib 177 is connected to the first portion 72c below the first inflow portion 96b.

In the present embodiment, both the first inflow portion 96b and the first outflow portion 97a are open to the first portion 72c. According to the present embodiment, since the first rib 177 is connected to the first inner side surface 72b, at least a part of the fluid O flowing downward along the first inner side surface 72b reaches the first outflow portion 97a after flowing along the first rib 177. As a result, it is possible to suppress the fluid O from immediately flowing out from the inside of the first bearing holding portion 172 to the outside via the first outflow portion 97a, and the fluid O is easily supplied to the first bearing B3.

The second bearing holding portion 71 has a second facing surface 71a and a second inner side surface 71b as in the above-described embodiment. On the second inner side surface 71b, a second inflow portion 97b and a second outflow portion 99a are open. That is, the flow path 90 has the second inflow portion 97b and the second outflow portion 99a. The second facing surface 71a is provided with a second rib 76. The second inner side surface 71b has a third portion 71c (first portion of the first embodiment) and a fourth portion 71d (second portion of the first embodiment) partitioned by a second dividing line L1 (first dividing line of the first embodiment). In the present embodiment, the second inflow portion 97b and the second outflow portion 99a are open to the third portion 71c. The second rib 76 is connected to the third portion 71c below the second inflow portion 97b. As in the first embodiment, by providing the second rib 76 in the second bearing holding portion 71, it is possible to suppress the fluid O from immediately flowing out from the inside of the second bearing holding portion 71 to the third bearing holding portion via the second outflow portion 99a, and the fluid O is easily supplied to the second bearing B1.

The feed portion 95 is provided in the gear chamber 6B and supplies the fluid O into the gear chamber 6B. The supply flow path portion 96 connects the feed portion 95 and the first inflow portion 96b. The supply flow path portion 96 of the present embodiment is located below an upper end portion 172p of the first bearing holding portion 172 and above the first axis J2. Since the supply flow path portion 96 of the present embodiment is not disposed so as to extend upward with respect to the first bearing holding portion 172, the dimension of the housing 106 in the vertical direction can be reduced.

The communication flow path portion 97 connects the first outflow portion 97a and the second inflow portion 97b. According to the present embodiment, part of the fluid O flowing into the first bearing holding portion 172 can be used for lubricating the first bearing B3, and the other part can be supplied to the second bearing holding portion 71 and used for lubricating the second bearing B1. According to the present embodiment, each of the first bearing holding portion 172 and the second bearing holding portion 71 includes the first rib 177 or the second rib 76. Therefore, the first bearing holding portion 172 and the second bearing holding portion 71 can supply the fluid O flowing into therein to the downstream side from the respective outflow portions while sufficiently using the fluid O for lubricating the bearings B3 and B1.

In the present embodiment, the first rib 177 and the second rib 76 extend in different directions from each other in a direction orthogonal to the axial direction. According to the present embodiment, the shapes of the first rib 177 and the second rib 76 can be optimized according to the arrangement of the first inflow portion 96b and the first outflow portion 97a opened to the first bearing holding portion 172, and the second inflow portion 97b and the second outflow portion 99a opened to the second bearing holding portion 71.

A first rib 177F and a second rib 76F of a fifth modification that can be adopted in the drive device of the second embodiment will be described. In the description of the present modification, the same reference sign is given to the same component as that in the embodiment or modification that has been described already, and the description thereof will be omitted.

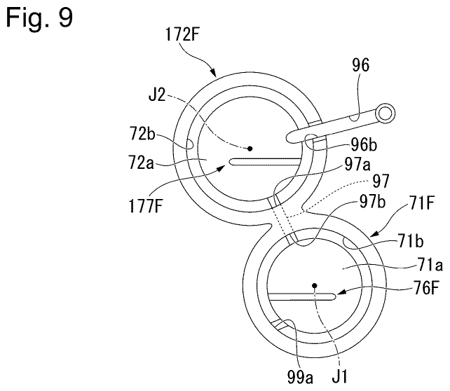

FIG. 9 is a schematic view of a first bearing holding portion 172F and a second bearing holding portion 71F of the fifth modification. The first bearing holding portion 172F of the present modification has a first facing surface 72a and a first inner side surface 72b as in the above-described embodiment. In the present modification, the first facing surface 72a is provided with the first rib 177F. At least a part of the first rib 177F is located below the first inflow portion 96b, and at least a part covers the first outflow portion 97a from above. Similarly, the second bearing holding portion 71F of the present modification has a second facing surface 71a and a second inner side surface 71b. In the present modification, the second facing surface 71a is provided with the second rib 76F. At least a part of the second rib 76F is located below the second inflow portion 97b, and at least a part covers the second outflow portion 99a from above.

In the present modification, the first rib 177F and the second rib 76F extend along the horizontal direction. According to the present modification, even when the vehicle is inclined, the inclination angles of the first rib 177F and the second rib 76F are smaller than those in the case where the ribs are disposed to be inclined as in the first embodiment. Therefore, the first rib 177F and the second rib 76F can stably supply the fluid O to the bearings B3 and B1 inside the first bearing holding portion 172F or the second bearing holding portion 71F, respectively.

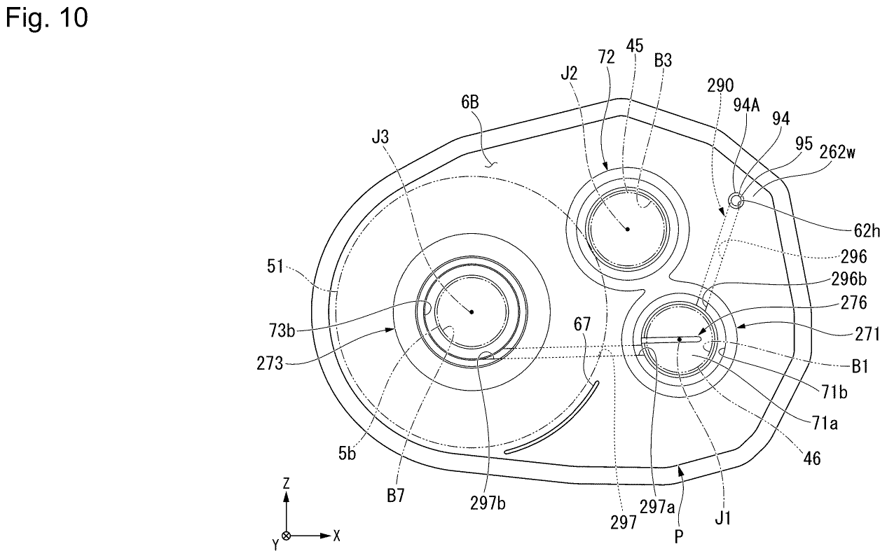

FIG. 10 is a front view of a side wall 262w according to the drive device of the third embodiment. The side wall 262w of the present embodiment is different from the above-described embodiment mainly in the configuration of a flow path 290.

Note that members or portions that have their equivalents in the above-described embodiment are denoted by the same reference numerals as those of their equivalents in the above-described embodiment, and descriptions of those members or portions are omitted.

A second shaft 5b of the present embodiment has the same configuration as the third shaft 5b of the first embodiment. The second bearing B7 of the present embodiment has the same configuration as the third bearing B7 of the first embodiment. A first bearing holding portion 271 of the present embodiment has the same configuration as the first bearing holding portion 71 of the first embodiment except that the arrangement and the like of a first inflow portion 296b and a second outflow portion 297a are different. A second bearing holding portion 273 of the present embodiment has the same configuration as the third bearing holding portion 73 of the first embodiment except that a second inflow portion 297b is provided. A third bearing holding portion 72 of the present embodiment has the same configuration as the second bearing holding portion 72 of the first embodiment except that an inflow portion and an outflow portion are not provided.

The side wall 262w is provided with a first bearing holding portion 271, a second bearing holding portion 273, and a third bearing holding portion 72. The side wall 262w is provided with a feed portion 95 of the flow path 290, a supply flow path portion 296, and a communication flow path portion 297.

The first bearing holding portion 271 has a first facing surface 71a and a first inner side surface 71b as in the above-described embodiment. On the first inner side surface 71b, a first inflow portion 296b and a first outflow portion 297a are open. That is, the flow path 290 has the first inflow portion 296b and the first outflow portion 297a. The first facing surface 71a is provided with a first rib 276. The first rib 276 protrudes from the first facing surface 71a to the other side (−Y side) in the axial direction. The first rib 276 extends in a direction orthogonal to the axial direction. The first rib 276 extends linearly over the entire length when viewed from the axial direction. At least a part of the first rib 276 is located below the first inflow portion 296b. Therefore, the fluid O flowing from the first inflow portion 296b into the first bearing holding portion 271 is received by the first rib 276, and at least a part thereof flows along the first rib 276. At least a part of the first rib 276 covers the first outflow portion 297a from above. Therefore, it is possible to prevent the fluid O in the first bearing holding portion 271 from immediately reaching the first outflow portion 297a. According to the present embodiment, since the time during which the fluid O flows into the first bearing holding portion 271 becomes long, the fluid O is easily supplied to the first bearing B1. When the fluid O travels along the first rib 276, the fluid O is supplied to the first bearing B1, and more fluid can be supplied to the first bearing B1.

The second bearing holding portion 273 has a second inner side surface 73b. The second inflow portion 297b is open on the second inner side surface 73b. That is, the flow path 290 has the second inflow portion 297b. The fluid O flows into the second bearing holding portion 273 from the second inflow portion 297b to lubricate the second bearing B7.

The feed portion 95 is provided in the gear chamber 6B and supplies the fluid O into the gear chamber 6B. The supply flow path portion 296 connects the feed portion 95 and the first inflow portion 296b. The communication flow path portion 297 connects first outflow portion 297a and second inflow portion 297b. According to the present embodiment, part of the fluid flowing into the first bearing holding portion 271 can be used for lubricating the first bearing B1, and the other part of the fluid O can be moved to the second bearing holding portion 273 and used for lubricating the second bearing B7.

The second bearing B7 of the present embodiment rotatably supports the differential device 5. For this reason, a large force is likely to be applied to the second bearing B7 as compared with the other bearings B1 and B3, and seizure or the like is likely to occur. According to the present embodiment, by supplying the fluid O to the second bearing B7, seizure can be prevented, and the reliability of the drive device 1 can be enhanced.

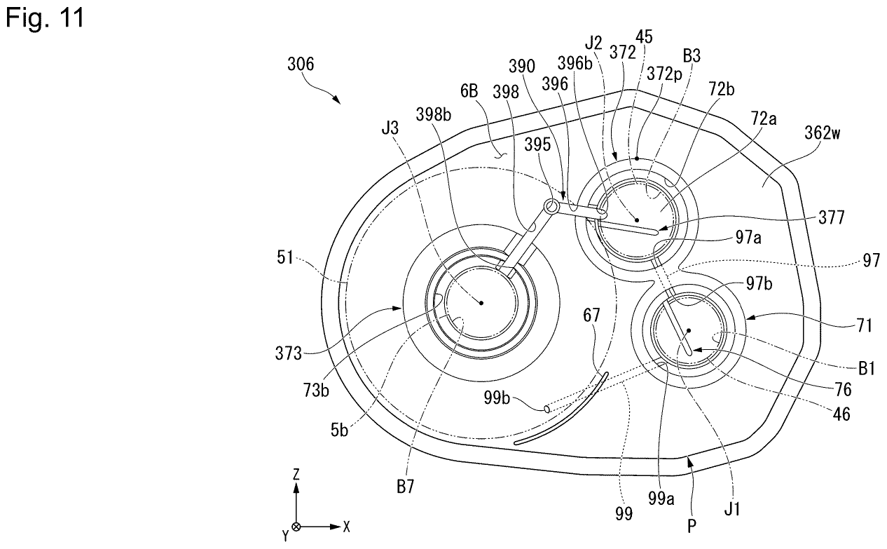

FIG. 11 is a front view of a side wall 362w according to a drive device of a fourth embodiment. The side wall 362w of the present embodiment is different from the above-described embodiment mainly in the configuration of a flow path 390.

Note that members or portions that have their equivalents in the above-described embodiment are denoted by the same reference numerals as those of their equivalents in the above-described embodiment, and descriptions of those members or portions are omitted.

A first shaft 45 of the present embodiment has the same configuration as the second shaft 45 of the first embodiment. A second shaft 46 of the present embodiment has the same configuration as the first shaft 46 of the first embodiment. The first bearing B3 of the present embodiment has the same configuration as the second bearing B3 of the first embodiment. The second bearing B1 of the present embodiment has the same configuration as the first bearing B1 of the first embodiment. The second bearing holding portion 71 of the present embodiment has the same configuration as the first bearing holding portion 71 of the first embodiment. In addition, a first bearing holding portion 372 of the present embodiment has the same configuration as that of the second bearing holding portion 72 of the first embodiment except that the first bearing holding portion has a first rib 377 and the arrangement of a first inflow portion 396b is different.

The side wall 362w is provided with a first bearing holding portion 372, a second bearing holding portion 71, and a third bearing holding portion 373. The side wall 362w is provided with a feed portion 395, a first supply flow path portion 396, a second supply flow path portion 398, a communication flow path portion 97, and a terminal flow path portion 99 of the flow path 390.

The first bearing holding portion 372 has a first facing surface 72a and a second inner side surface 72b as in the above-described embodiment. On the second inner side surface 72b, a first inflow portion 396b and a first outflow portion 97a are open. The first facing surface 72a is provided with a first rib 377. The first rib 377 protrudes from the first facing surface 72a to the other side (−Y side) in the axial direction. The first rib 377 extends in a direction orthogonal to the axial direction. The first rib 377 extends linearly over the entire length when viewed from the axial direction. At least a part of the first rib 377 is located below the first inflow portion 396b. At least a part of the first rib 377 covers the first outflow portion 97a from above.

The third bearing holding portion 373 holds the third bearing B7. The third bearing holding portion 373 has a third inner side surface 73b. The third inner side surface 73b is open on a third inflow portion 398b. That is, the flow path 390 has the third inflow portion 398b. The fluid O flows into the third bearing holding portion 373 from the third inflow portion 398b to lubricate the third bearing B7.

The feed portion 395 is provided in the gear chamber 6B and supplies the fluid O into the gear chamber 6B. The first supply flow path portion 396 connects the feed portion 395 and the first inflow portion 396b. The second supply flow path portion 398 connects the feed portion 395 and the third inflow portion 398b. That is, the second supply flow path portion 398 extends from the feed portion 395 to the inside of the third bearing holding portion 373. The fluid O supplied from the feed portion 395 to the gear chamber 6B branches and flows into the first supply flow path portion 396 and the second supply flow path portion 398. According to the present embodiment, the fluid O can be supplied from the feed portion 395 to each of the first bearing holding portion 372 and the third bearing holding portion 373. Part of the fluid O supplied to the first bearing holding portion 372 is supplied to the second bearing holding portion 71 via the communication flow path portion 97. According to the present embodiment, it is possible to supply the fluid O to the three bearings B1, B3, and B7 held by the side wall 362w to suppress seizure of these bearings B1, B3, and B7.

In the present embodiment, the third bearing holding portion 373 connected to the second supply flow path portion 398 supports the differential device 5 via the third bearing B7. According to the present embodiment, the fluid O can be stably supplied from the feed portion 395 to the third bearing holding portion 373, seizure of the third bearing B7 can be suppressed, and reliability of the drive device 1 can be enhanced.

The feed portion 395 of the present embodiment is located between the first axis J2 and the third axis J3 in the first direction (X-axis direction) intersecting both the first axis J2 (second axis line of the first embodiment) and the vertical direction. The feed portion 395 of the present embodiment can be arranged in the space between the first bearing holding portion 372 and the third bearing holding portion 373 in the first direction (X-axis direction), and the internal space of the gear chamber 6B is effectively used, so that a housing 306 can be downsized.

The feed portion 395 of the present embodiment is located below an upper end portion 372p of the first bearing holding portion 372 and above the first axis J2. Since the feed portion 395 of the present embodiment is not disposed so as to extend upward with respect to the first bearing holding portion 372 (that is, the feed portion 395 is disposed below the first bearing holding portion), the dimension of the housing 306 in the vertical direction can be reduced.

Although various embodiments of the present invention have been described above, configurations in the respective embodiments and combinations thereof are examples, and thus, addition, omission, replacement of configurations, and other modifications can be made within a range without departing from the spirit of the present invention. Also note that the present invention is not limited by the embodiment.

For example, in each of the above-described embodiments, the first rib, the second rib, and the third rib extending linearly when viewed from the axial direction are exemplified, but these ribs may be curved when viewed from the axial direction. In each of the above-described embodiments, the rib protruding from the facing surface integrally with the side wall has been exemplified, but the rib and the side wall may be separate members.

Further, in the above-described embodiment, the case where the first cylindrical portion, the second cylindrical portion, and the third cylindrical portion are provided integrally with the side wall has been described, but these may be configured by separate members fixed to the side wall. Each of the first cylindrical portion, the second cylindrical portion, and the third cylindrical portion may include a plurality of members. For example, the first facing surface and the first inner side surface may be parts of different members, the second facing surface and the second inner side surface may be parts of different members, and the third facing surface and the third inner side surface may be parts of different members.

In each of the above-described embodiments, the case where the first bearing holding portion, the second bearing holding portion, and the third bearing holding portion are provided on the side wall located on one side in the axial direction of the motor chamber has been described. However, the side wall provided with the first bearing holding portion, the second bearing holding portion, and the third bearing holding portion may be a partition wall that partitions the gear chamber and the motor chamber.

The configuration of each axis of the transmission mechanism of each embodiment described above is an example. The number of shafts constituting the transmission mechanism is not limited to three. Two of the plurality of shafts may be coaxially arranged such that one passes through the other hollow portion. The fluid O stored in the housing 6 is not particularly limited, and may be a fluid other than oil. The fluid supplied to the motor by the fluid feed portion may be, for example, water.

Note that the present technique can have the following configurations.

(1) A drive device including: a motor; a transmission mechanism configured to transmit power of the motor; a housing provided with a gear chamber that accommodates the transmission mechanism; and a flow path at least a part of which is provided in the housing, in which the transmission mechanism includes: a first shaft rotatable about a first axis; and a first bearing that supports the first shaft, the housing includes: a side wall covering the gear chamber from one side in an axial direction; and a first bearing holding portion that is provided on the side wall and holds the first bearing, the first bearing holding portion includes: a first facing surface located on one side in an axial direction with respect to an end portion on one side in an axial direction of the first shaft and extending in a direction orthogonal to the axial direction; and a first inner side surface extending in the axial direction and supporting the first bearing from a radially outer side about the first axis, the flow path includes: a first inflow portion that is open to the first inner side surface; and a first outflow portion that is positioned below the first inflow portion and open to the first inner side surface, the first facing surface is provided with a first rib protruding to an other side in the axial direction and extending in the direction orthogonal to the axial direction, and at least a part of the first rib is located below the first inflow portion, and at least a part of the first rib covers the first outflow portion from above.

(2) The drive device according to (1), in which assuming a first dividing line passing through the first axis and extending in a vertical direction when viewed from the axial direction, the first inner side surface includes a first portion and a second portion partitioned by the first dividing line, the first inflow portion is open to the first portion, the first outflow portion is open to the first portion, and the first rib is connected to the first portion below the first inflow portion.

(3) The drive device according to (1) or (2), in which the flow path includes: a feed portion that is provided in the gear chamber and supplies a fluid; and a supply flow path portion connecting the feed portion and the first inflow portion, and the supply flow path portion is located below an upper end portion of the first bearing holding portion and above the first axis.

(4) The drive device according to any one of (1) to (3), in which the first rib extends linearly over an entire length when viewed in the axial direction.

(5) The drive device according to any one of (1) to (4), in which the transmission mechanism includes: a second shaft rotatable about a second axis parallel to the first axis; and a second bearing that supports the second shaft, the housing includes a second bearing holding portion that is provided in the side wall and holds the second bearing, the second bearing holding portion has a second inner side surface that supports the second bearing from a radially outer side with the second axis line as a center, and the flow path includes: a second inflow portion that is open to the second inner side surface; and a communication flow path portion that connects the first outflow portion and the second inflow portion.

(6) The drive device according to (5), in which the second bearing holding portion has a second facing surface located on one side in an axial direction with respect to an end portion on one side in an axial direction of the second shaft and extending in the direction orthogonal to the axial direction, the flow path includes a second outflow portion located below the second inflow portion and open to the second inner side surface, the second facing surface is provided with a second rib protruding to an other side in the axial direction and extending in the direction orthogonal to the axial direction, and at least a part of the second rib is located below the second inflow portion, and at least a part of the second rib covers the second outflow portion from above.

(7) The drive device according to (6), in which assuming a second dividing line passing through the first axis and extending in the vertical direction when viewed from the axial direction, the second inner side surface includes a third portion and a fourth portion partitioned by the second dividing line, the second inflow portion is open to the third portion, the second outflow portion is open to the third portion, and the second rib is connected to the third portion below the second inflow portion.

(8) The drive device according to (6) or (7), in which the first rib and the second rib extend in different directions from each other in the direction orthogonal to the axial direction.

(9) The drive device according to (6) or (7), in which the first rib and the second rib extend along a horizontal direction.

(10) The drive device according to any one of (1) to (9), in which the transmission mechanism includes: a third shaft rotatable about a third axis parallel to the first axis; and a third bearing that supports the third shaft, the housing includes a third bearing holding portion that is provided on the side wall and holds the third bearing, the flow path includes: a feed portion that is disposed in the gear chamber and supplies a fluid; and a first supply flow path portion connecting the feed portion and the first inflow portion, and the feed portion is located between the first axis and the third axis in a first direction intersecting both the first axis and a vertical direction.

(11) The drive device according to (10), in which the flow path includes a second supply flow path portion extending from the feed portion to an inside of the third bearing holding portion.

(12) The drive device according to any one of (1) to (11), in which a plurality of the first ribs are provided on the first facing surface.

(13) The drive device according to any one of (1) to (12), in which the first facing surface is provided with a third rib protruding to an other side in the axial direction and extending in the direction orthogonal to the axial direction, assuming a first dividing line passing through the first axis and extending in the vertical direction when viewed from the axial direction, the first inner side surface includes a first portion and a second portion partitioned by the first dividing line, the first rib includes: a first end portion connected to the first portion; and a second end portion radially facing to the second portion with a gap interposed therebetween, the third rib includes: a third end portion connected to the second portion; and a fourth end portion radially facing the first portion with a gap interposed therebetween, and a position of the second end portion in an up-down direction is different from a position of the fourth end portion in an up-down direction.

(14) The drive device according to any one of (1) to (13), in which a notch recessed to one side in the axial direction is provided at an end portion on an other side in an axial direction of the first rib.

(15) The drive device according to any one of (1) to (14), in which the first rib is inclined upward toward an other side in the axial direction.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive device comprising:
a motor;
a transmission mechanism configured to transmit power of the motor;
a housing provided with a gear chamber that accommodates the transmission mechanism; and
a flow path at least a part of which is provided in the housing, wherein
the transmission mechanism includes:
a first shaft rotatable about a first axis; and
a first bearing that supports the first shaft,
the housing includes:
a side wall covering the gear chamber from one side in an axial direction; and
a first bearing holding portion that is provided on the side wall and holds the first bearing,
the first bearing holding portion includes:
a first facing surface located on one side in an axial direction with respect to an end portion on one side in an axial direction of the first shaft and extending in a direction orthogonal to the axial direction; and
a first inner side surface extending in the axial direction and supporting the first bearing from a radially outer side about the first axis,
the flow path includes:
a first inflow portion that is open to the first inner side surface; and
a first outflow portion that is positioned below the first inflow portion and open to the first inner side surface,
the first facing surface is provided with a first rib protruding to an other side in the axial direction and extending in the direction orthogonal to the axial direction, and
at least a part of the first rib is located below the first inflow portion, and at least a part of the first rib covers the first outflow portion from above.

2. The drive device according to claim 1, wherein
assuming a first dividing line passing through the first axis and extending in a vertical direction when viewed from the axial direction,
the first inner side surface includes a first portion and a second portion partitioned by the first dividing line,
the first inflow portion is open to the first portion,
the first outflow portion is open to the first portion, and
the first rib is connected to the first portion below the first inflow portion.

3. The drive device according to claim 1, wherein
the flow path includes:
a feed portion that is provided in the gear chamber and supplies a fluid; and
a supply flow path portion connecting the feed portion and the first inflow portion, and
the supply flow path portion is located below an upper end portion of the first bearing holding portion and above the first axis.

4. The drive device according to claim 1, wherein the first rib extends linearly over an entire length when viewed in the axial direction.

5. The drive device according to claim 1, wherein
the transmission mechanism includes:
a second shaft rotatable about a second axis parallel to the first axis; and
a second bearing that supports the second shaft,
the housing includes a second bearing holding portion that is provided in the side wall and holds the second bearing,
the second bearing holding portion has a second inner side surface that supports the second bearing from a radially outer side with the second axis line as a center, and
the flow path includes:
a second inflow portion that is open to the second inner side surface; and
a communication flow path portion that connects the first outflow portion and the second inflow portion.

6. The drive device according to claim 5, wherein
the second bearing holding portion has a second facing surface located on one side in the axial direction with respect to an end portion on one side in an axial direction of the second shaft and extending in the direction orthogonal to the axial direction,
the flow path includes a second outflow portion located below the second inflow portion and open to the second inner side surface,
the second facing surface is provided with a second rib protruding to an other side in the axial direction and extending in the direction orthogonal to the axial direction, and
at least a part of the second rib is located below the second inflow portion, and at least a part of the second rib covers the second outflow portion from above.

7. The drive device according to claim 6, wherein
assuming a second dividing line passing through the first axis and extending in the vertical direction when viewed from the axial direction,
the second inner side surface includes a third portion and a fourth portion partitioned by the second dividing line,
the second inflow portion is open to the third portion,
the second outflow portion is open to the third portion, and
the second rib is connected to the third portion below the second inflow portion.

8. The drive device according to claim 6, wherein the first rib and the second rib extend in different directions from each other in the direction orthogonal to the axial direction.

9. The drive device according to claim 6, wherein the first rib and the second rib extend along a horizontal direction.

10. The drive device according to claim 1, wherein
the transmission mechanism includes:
a third shaft rotatable about a third axis parallel to the first axis; and
a third bearing that supports the third shaft,
the housing includes a third bearing holding portion that is provided on the side wall and holds the third bearing,
the flow path includes:
a feed portion that is disposed in the gear chamber and supplies a fluid; and
a first supply flow path portion connecting the feed portion and the first inflow portion, and
the feed portion is located between the first axis and the third axis in a first direction intersecting both the first axis and the vertical direction.

11. The drive device according to claim 10, wherein the flow path includes a second supply flow path portion extending from the feed portion to an inside of the third bearing holding portion.

12. The drive device according to claim 1, wherein a plurality of the first ribs are provided on the first facing surface.

13. The drive device according to claim 1, wherein
the first facing surface is provided with a third rib protruding to an other side in the axial direction and extending in the direction orthogonal to the axial direction,
assuming a first dividing line passing through the first axis and extending in the vertical direction when viewed from the axial direction,
the first inner side surface includes a first portion and a second portion partitioned by the first dividing line,
the first rib includes:
a first end portion connected to the first portion; and
a second end portion radially facing to the second portion with a gap interposed therebetween,
the third rib includes:
a third end portion connected to the second portion; and
a fourth end portion radially facing the first portion with a gap interposed therebetween, and
a position of the second end portion in an up-down direction is different from a position of the fourth end portion in an up-down direction.

14. The drive device according to claim 1, wherein a notch recessed to one side in the axial direction is provided at an end portion on an other side in an axial direction of the first rib.

15. The drive device according to claim 1, wherein the first rib is inclined upward toward an other side in the axial direction.
